(19) United States
(12) Patent Application Publication
(10) Pub. No.: US 2005/0144000 A1
(43) Pub. Date: Jun. 30, 2005

(54) Contents providing apparatus and method

(75) Inventors: Tomohiro Yamasaki, Kanagawa-ken (JP); Akihiko Ohsuga, Kanagawa-ken (JP); Masanori Hattori, Kanagawa-ken (JP); Kenta Cho, Tokyo (JP); Hisashi Hayashi, Kanagawa-ken (JP); Kouji Ueno, Kanagawa-ken (JP); Kentaro Kamahora, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/017,790

(22) Filed: Dec. 22, 2004

(30) Foreign Application Priority Data
Dec. 26, 2003 (JP) P2003-434403

(51) Int. Cl. G06F 17/27

(52) U.S. Cl. 704/252

(57) ABSTRACT

A context recognition unit decides a user's context by comparing context recognition rules to the user's information, and outputs context recognition data based on the user's context. A processing selection unit decides a contents type by comparing processing selection rules to the context recognition data, and outputs contents creation request data based on the contents type. A contents delivery unit obtains contents based on the contents creation request data, and delivers the contents to the user's terminal. A question creation unit creates a question about the contents delivery for the user. Each context recognition rule and each processing selection rule includes a priority degree. The question creation unit specifies the context recognition rule or the processing selection rule based on the user's answer to the question, and changes the priority degree of the specified rule.

### CROSS-REFERENCE TO RELATED APPLICATIONS

This application is based upon and claims the benefit of priority from prior Japanese Patent Application P2003-434403, filed on Dec. 26, 2003; the entire contents of which are incorporated herein by reference.

### FIELD OF THE INVENTION

The present invention relates to a contents providing apparatus and a method for dynamically generating contents as personal information based on a user's physical environment, behavior patterns, and preferences in a ubiquitous environment.

### BACKGROUND OF THE INVENTION

Recently, in proportion to development of a communication network technique and miniaturization/mass storage of a terminal apparatus, a terminal function is installed onto not only in a PC (Personal Computer) but in various kinds of mobile devices such as a cellular phone or a car navigation system. Furthermore, by installing a terminal function onto a home electronic product such as a television or a refrigerator, a function as an information device can be realized.

Such environment, which includes various information devices on a communication network, is called a ubiquitous environment. In the ubiquitous environment, various kinds of technique to provide contents based on a user's physical environment, behavior patterns, and preferences are proposed. For example, as a method for providing a specified service by autonomously combining a plurality of service component elements, Japanese Patent Disclosure (Kokai) 2003-248728 is known. In this method, by directly communicating a plurality of service component elements, it is evaluated whether a present service is suitable for a user. Based on the evaluation result, combination of service component elements is recomposed.

However, in above-mentioned prior art, based on existing information previously preserved for a user, combination of existing service component element is only provided for the user. In other words, personal information is not dynamically generated based on the user's present situation. Accordingly, contents as personal information can not be suitably presented to the user with passage of time.

### SUMMARY OF THE INVENTION

The present invention is directed to a contents providing apparatus and method which dynamically generate contents as personal information based on the user's physical environment, behavior patterns and preferences at the present time.

According to an aspect of the present invention, there is provided an apparatus for providing contents through a communication network, comprising: a context recognition unit configured to decide a user's context by comparing context recognition rules to present information related to the user, the present information being data sent from a plurality of information devices through the communication network, and configured to output context recognition data based on the user's context; a processing selection unit configured to decide a contents type by comparing processing selection rules to the context recognition data, and configured to output contents creation request data based on the contents type; a contents delivery unit configured to obtain contents based on the contents creation request data, and configured to deliver the contents to a terminal related to the user; and a question creation unit configured to create at least one question about the contents delivery, the question being delivered in correspondence with the contents; wherein each context recognition rule and each processing selection rule include a priority degree for matching, and wherein said question creation unit, in response to the user's answer to the question, specifies the context recognition rule or the processing selection rule based on the answer, and changes the priority degree of the specified rule.

According to another aspect of the present invention, there is also provided a method for providing contents through a communication network, comprising: deciding a user's context by comparing context recognition rules to present information related to the user, each context recognition rule including a priority degree for matching, the present information being data sent from a plurality of information devices through the communication network; outputting context recognition data based on the user's context; deciding a contents type by comparing processing selection rules to the context recognition data, each processing selection rule including a priority degree for matching; outputting contents creation request data based on the contents type; obtaining contents based on the contents creation request data; delivering the contents to a terminal related to the user; creating at least one question about the contents delivery, the question being delivered in correspondence with the contents; specifying the context recognition rule or the processing selection rule based on the user's answer to the question; and changing the priority degree of the specified rule.

According to still another aspect of the present invention, there is also provided computer program product, comprising: a computer readable program code embodied in said product for causing a computer to provide contents through a communication network, said computer readable program code comprising: a first program code to decide a user's context by comparing context recognition rules to present information related to the user, each context recognition rule including a priority degree for matching, the present information being data sent from a plurality of information devices through the communication network; a second program code to output context recognition data based on the user's context; a third program code to decide a contents type by comparing processing selection rules to the context recognition data, each processing selection rule including a priority degree for matching; a fourth program code to output contents creation request data based on the contents type; a fifth program code to obtain contents based on the contents creation request data; a sixth program code to deliver the contents to a terminal related to the user; a seventh program code to create at least one question about the contents delivery, the question being delivered in correspondence with the contents; a eighth program code to specify the context recognition rule or the processing selection rule based on the user's answer to the question; and a ninth program code to change the priority degree of the specified rule.

### BRIEF DESCRIPTION OF THE DRAWINGS

FIG. 1 is a block diagram of a contents providing service system according to one embodiment of the present invention.

FIG. 2 is a flow chart of processing of a contents providing apparatus in FIG. 1.

FIG. 3 is one example of input data based on a user's environment and real-time behavior.

FIG. 4 is a flow chart of context recognition processing in FIG. 2.

FIG. 5 is one example of a context recognition rule used in the context recognition processing of FIG. 4.

FIG. 6 is a flow chart of processing selection processing in FIG. 2.

FIG. 7 is one example of a processing selection rule used in the processing selection processing of FIG. 6.

FIG. 8 is a flow chart of contents delivery processing in FIG. 2.

FIG. 9 is one example of a correspondence table used in the contents delivery processing of FIG. 8.

FIG. 10 is a flow chart of question creation processing in FIG. 2.

FIG. 11 is one example of a question created in the question creation processing of FIG. 10.

FIG. 12 is a flow chart of feedback processing in FIG. 2.

FIG. 13 is a flow chart of the feedback processing of context recognition rule in FIG. 12.

FIG. 14 is a flow chart of the feedback processing of processing selection rule in FIG. 12.

FIG. 15 is one example of a correspondence table used in processing of FIGS. 13 and 14.

FIG. 16 is one example of a distance table used in processing of FIGS. 13 and 14.

FIG. 17 is one example of a feedback rule used in processing of FIGS. 13 and 14.

FIG. 18 is a flow chart of rule extraction processing in FIG. 2.

### DETAILED DESCRIPTION OF THE EMBODIMENTS

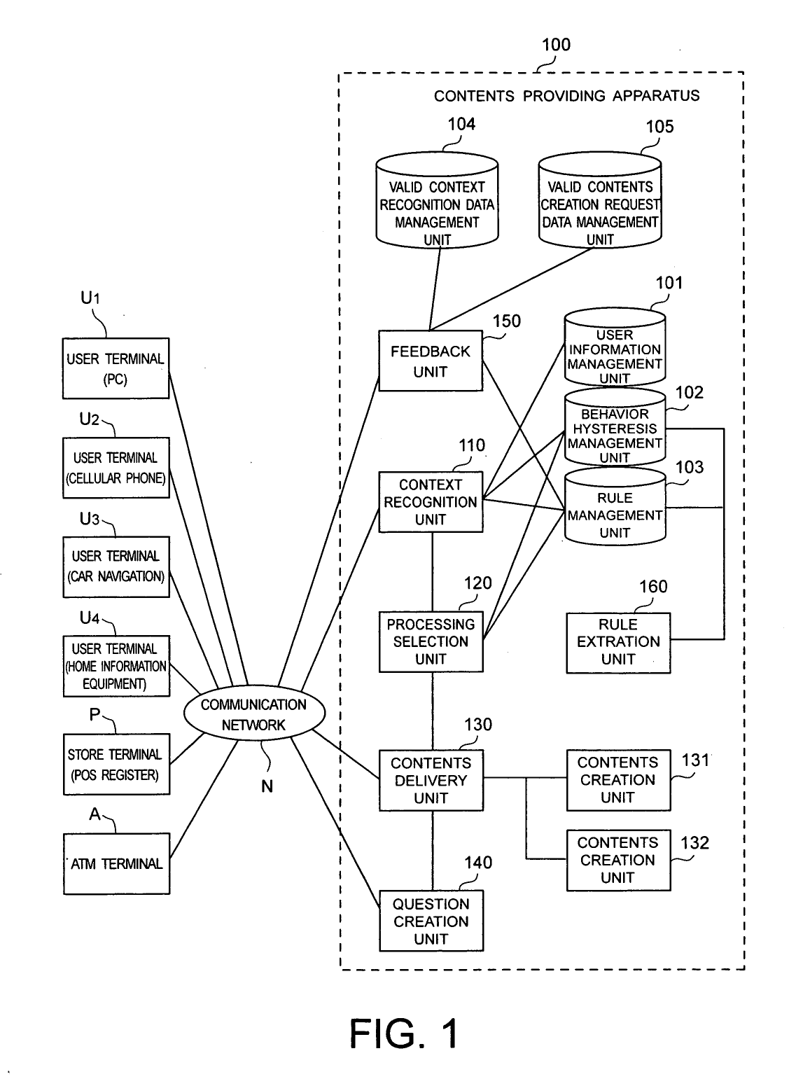

Hereinafter, various embodiments of the present invention will be explained by referring to the drawings. FIG. 1 is a block diagram of an information providing service system according to one embodiment of the present invention.

The information providing service system is realized in a ubiquitous environment in which various kinds of information devices are connected to a communication network. A purpose of this service system is providing personal information for a user at a suitable timing in various life scenes of the user.

In FIG. 1, a contents providing apparatus 100 is connected to various kinds of information devices through a communication network N. As the various kinds of information devices, a user terminal (PC) U1, a user terminal (cellular phone) U2, a user terminal (car navigation) U3, a user terminal (home information equipment) U4, a store terminal (POS register) P, and an ATM terminal A, are shown.

The contents providing apparatus 100 monitors an operation of the PC (user terminal U1) in a user's home or office, an operation of the cellular phone (user terminal U2), an operation of the car navigation (user terminal U3), an operation of the home information equipment (user terminal U4) such as a refrigerator, an operation of the POS register (store terminal P) located in a super market, and an operation of the ATM (ATM terminal A). By monitoring various kinds of information devices operated by the user, the contents providing apparatus 100 obtains information related to the user oneself and data related to the user's real time behavior, and realizes an agent service providing information suitable for the user individual.

As shown in FIG. 1, the contents providing apparatus 100 includes a user information management unit 101, a behavior hysteresis management unit 102, a rule management unit 103, a valid context recognition data management unit 104, a valid contents creation request data management unit 105, a context recognition unit 110, a processing selection unit 120, a contents delivery unit 130, contents creation units 131 and 132, a question creation unit 140, a feedback unit 150 and a rule extraction unit 160. Hereinafter, the operation of each unit is explained.

The user information management unit 101 stores and manages private information related to the user as user information. The user information includes basic information to specify each user such as a name, a telephone number, an address, a mail address, and a user identifier for security and feature information of each user's definite feature as a base of service provision such as the user's hobby and preferences.

The behavior hysteresis management unit 102 stores and manages behavior hysteresis data representing when, where, and how each user behaves. The behavior hysteresis data includes (data obtained from various kinds of information devices on the communication network N) context recognition data output from the context recognition unit 110 and contents creation request data output from the processing selection unit 120.

The rule management unit 103 stores and manages a context recognition rule to decide a present context of each user and a processing selection rule to decide a type of contents to be provided for each user. The context recognition rule and the processing selection rule include a priority degree for matching, kinds of input data and output data, and a condition as a property.

The valid context recognition data management unit 104 stores and manages the context recognition data used for feedback processing by the feedback unit 150 as valid context recognition data. The valid contents creation request data management unit 105 stores and manages the contents creation request data used for feedback processing by the feedback unit 150 as valid contents creation request data.

The context recognition unit 110 inputs data obtained from various kinds of information devices on the communication network N, the user information stored in the user information management unit 101, or the behavior hysteresis data stored in the behavior hysteresis management unit 102. By comparing input data to the context recognition rule stored in the rule management unit 103, the context recognition unit 110 decides the user's present context and outputs context recognition data based on the present context.

The processing selection unit 120 inputs the context recognition data output from the context recognition unit 110. By comparing input data (the context recognition data) to the processing selection rule stored in the rule management unit 103, the processing selection unit 120 decides a type of contents to be provided for the user and outputs contents creation request data based on the type of contents.

The contents delivery unit 130 selects one contents creation unit to create contents to be provided for the user from a plurality of contents creation units 131 and 132 based on the contents creation request data output from the processing selection unit 120, and obtains contents created by the selected contents creation unit. Furthermore, the contents delivery unit 130 selects a terminal related to the user as a delivery destination terminal, and sends the contents to the delivery destination terminal.

As the contents creation units 131 and 132, various means based on a type of contents or a purpose such as a notification message creation unit or a store guide creation unit, can be used. In FIG. 1, two contents creation units 131 and 132 are only shown in order to simplify the explanation. However, many contents creation units may be used in order to create contents of various types.

In the case of contents delivery processing by the contents delivery unit 130, the question creation unit 140 creates a question form to clarify a reason of the contents delivery and a processing of the contents delivery for the user. The question form includes the context recognition data as the reason of the contents delivery. Furthermore, the question creation unit 140 obtains the user's answer representing whether the reason and the processing of contents delivery were proper. In response to the user's answer, the question creation unit 140 specifies a context recognition rule or a processing selection rule based on the answer, and updates the priority degree of the specified rule.

Briefly, if the user's answer represents whether the reason of the contents delivery was proper, the question creation unit 140 specifies the context recognition rule used for output of the context recognition data (the reason), and updates the priority degree of the specified rule. Furthermore, if the user's answer represents whether the processing of the contents delivery was proper, the question creation unit 140 specifies the processing selection rule used for output of the contents creation request data, and updates the priority degree of the specified rule.

The feedback unit 150 previously stores correspondence information between processed data, such as the context recognition data and the contents creation request data, and data obtained from various kinds of information devices. Next, actual data obtained from various kinds of information devices is regarded as input data, and actual data output from the context recognition unit 110 or the processing selection unit 120 is regarded as output data. The feedback unit 150 searches the same pair of the input data and the output data from the correspondence information, and updates the context recognition rule or the processing selection rule based on the correspondence information of the same pair.

Briefly, if the output data is the context recognition data, the feedback unit 150 specifies the context recognition rule based on the correspondence information of the same pair. If the output data is the contents creation request data, the feedback unit 150 specifies the processing selection rule based on the correspondence information of the same pair. By updating the priority degree of the specified rule, each rule stored in the rule management unit 103 is changed.

The rule extraction unit 160 measures (counts) a frequency of the same combination of the context recognition data, input data from various kinds of information devices (or information related to the user self), and the contents creation request data. The rule extraction unit 160 extracts new rule from the combination of these data having a high frequency as a context recognition rule or a processing selection rule, and adds the new rule to the rule management unit 103.

Briefly, the rule extraction unit 160 measures a frequency of the same combination of the context recognition data and the input data (or the same information of the user self), and extracts the same combination of high frequency as a new context recognition rule. Furthermore, the rule extraction unit 160 measures a frequency of the same combination of the context recognition data and the contents creation request data, and extracts the same combination of high frequency as a new processing selection rule.

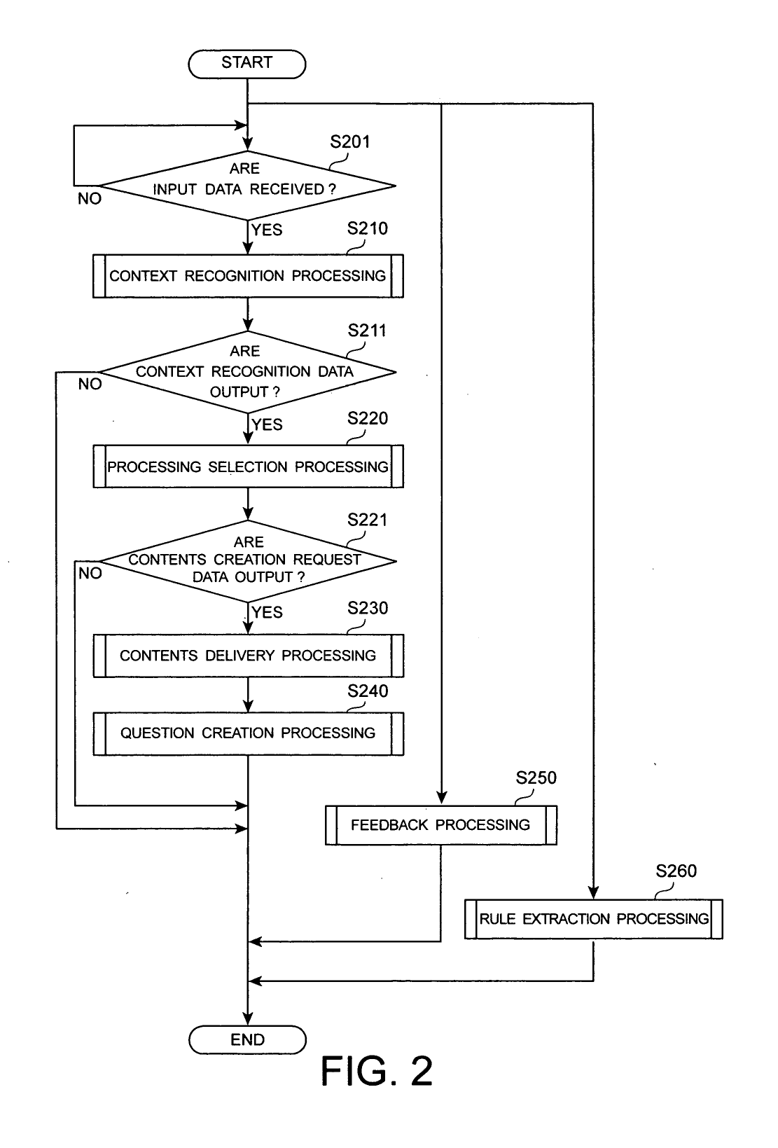

FIG. 2 is a flow chart of generic processing of the contents providing apparatus according to one embodiment of the present invention. As shown in FIG. 2, when the contents providing apparatus 100 receives input data related to the user from various kinds of information devices connected to the communication network N (Yes at S201), the context recognition unit 110 compares the input data with each context recognition rule stored in the rule management unit 103, decides the user's present context based on the context recognition rule matched with the input data, and outputs context recognition data based on the user's present context (S210). In the same way, in case of obtaining user information stored in the user information management unit 101 or behavior hysteresis data stored in the behavior hysteresis management unit 102, the context recognition unit 110 executes context recognition processing of the input data.

As a result of context recognition processing by the context recognition unit 110, when the context recognition data is output (Yes at S211), the processing selection unit 120 compares the context recognition data with each processing selection rule stored in the rule management unit 103, decides a type of contents to be provided for the user based on the processing selection rule matched with the context recognition data, and outputs contents creation request data based on the type of contents (S220).

As a result of processing selection processing by the processing selection unit 120, when the contents creation request data is output (Yes at S221), the contents delivery unit 130 executes contents delivery processing (S230). Briefly, based on the contents creation request data, the contents delivery unit 130 selects one contents creation unit to create contents to be provided for the user from a plurality of contents creation units 131 and 132, and obtains contents created by the selected contents creation unit. Furthermore, the contents delivery unit 130 selects a user terminal (U1-U4) related to the user as a delivery destination terminal, and sends the contents to the delivery destination terminal.

In the case of contents delivery processing by the contents delivery unit 130, the question creation unit 140 executes question creation processing (S240). First, the question creation unit 140 sets the context recognition data from which the contents delivery is caused as a reason of the contents deliver, and creates a question form clarifying the reason and the processing of the contents delivery. The question form is delivered with the contents or sometimes after delivering the contents to the delivery destination terminal. When the question creation unit 140 receives the user's answer representing whether the reason and/or the processing of the contents delivery was proper, the question creation unit 140 specifies the contents recognition rule or the processing selection rule based on the answer, and updates the priority degree of the specified rule.

In the contents providing apparatus 100, the feedback unit 150 executes feedback processing (S250) in parallel with the context recognition processing, the processing selection processing, the contents delivery processing and the question creation processing (S210˜S240).

The feedback unit 150 previously stores correspondence information between each output data of the context recognition data and the contents creation request data and each input datum obtained from various kinds of information devices. Next, whenever the contents delivery unit 130 executes the contents delivery processing, the feedback unit 150 obtains context recognition data actually output from the context recognition unit 110, and obtains contents creation request data actually output from the processing selection unit 120. The feedback unit 150 stores the contents recognition data in the valid context recognition data management unit 104, and stores the contents creation request data in the valid contents creation request data management unit 105.

Furthermore, whenever the contents recognition unit 110 begins contents recognition processing in response to input data from various kinds of information devices, the feedback unit 150 combines the input data with the context recognition data stored in the valid context recognition data management unit 104 and the contents creation request data stored in the valid contents creation request data management unit 105. The feedback unit 150 searches the correspondence information of the same combination of the input data and the output data, specifies the context recognition rule and/or the processing selection rule based on the searched correspondence information, and updates the priority degree of the specified rule.

In the contents providing apparatus 100, in parallel with the context recognition processing, the processing selection processing, the contents delivery processing, the question creation processing and the feedback processing (S210˜250), the rule extraction unit 160 executes rule extraction processing (S260) at a predetermined interval or at a predetermined times of execution of the context recognition processing or the processing selection processing.

The rule extraction unit 160 measures a frequency of the same combination of the context recognition data, input data from various kinds of information devices (or data related to the user self), and the contents creation request data. The rule extraction unit 160 extracts a new rule from the combination of these data having a high frequency as a context recognition rule or a processing selection rule, and stores the new rule in the rule management unit 103.

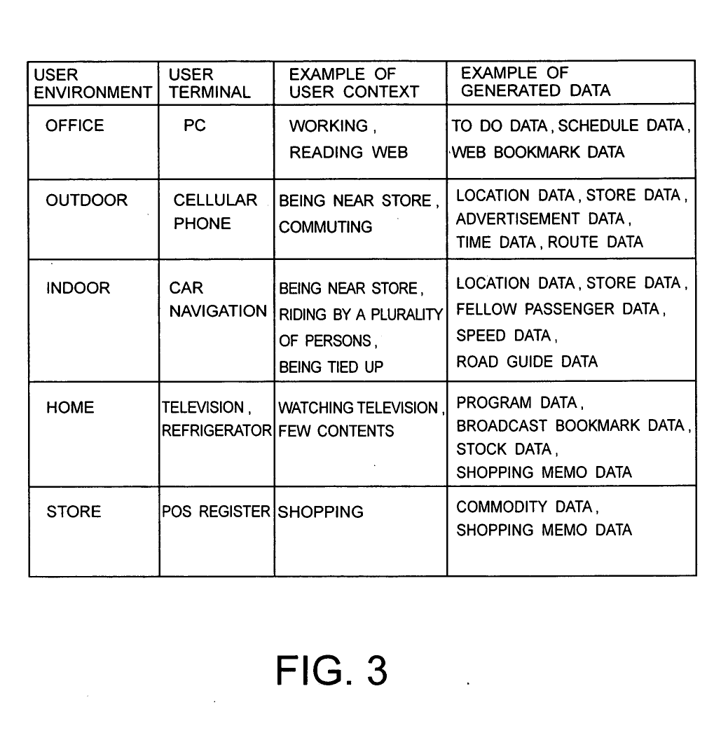

Hereinafter, processing of the contents providing apparatus shown in FIGS. 1 and 2 is explained by referring to FIGS. 3˜18.

FIG. 3 is one example of a data display diagram representing a relationship among a user's environment, a user's context, and generated data by a user's real time behavior. As shown in FIG. 3, when a user is in a store and the user is shopping, in the case of account processing at a POS register in the store, commodity data and shopping memo data are generated.

Concretely, for example, assume that a user having purpose “buy a carrot” and “buy an onion” is shopping in a super market, and the user purchases the carrot only. In this case, the POS register obtains data “how much the amount sold increased”, “how much the stocks of carrot decreased”, “how much the user's money in hand decreased” and “how much the user's belongings increased”.

In this case, assume that the user recognizes that he/she must withdraw money because of decrease of his/her money in hand, and the user registers “To Do memo data” such as “withdraw money” and “buy an onion” by activating a schedule management application of a cellular phone in order not to forget buying an onion not bought in this super market. In this way, data generated from each terminal related to the user, and data registered by the user, are sent to the contents providing apparatus 100 through the communication network by, if necessary, adding a user identifier from the terminal where the data was generated.

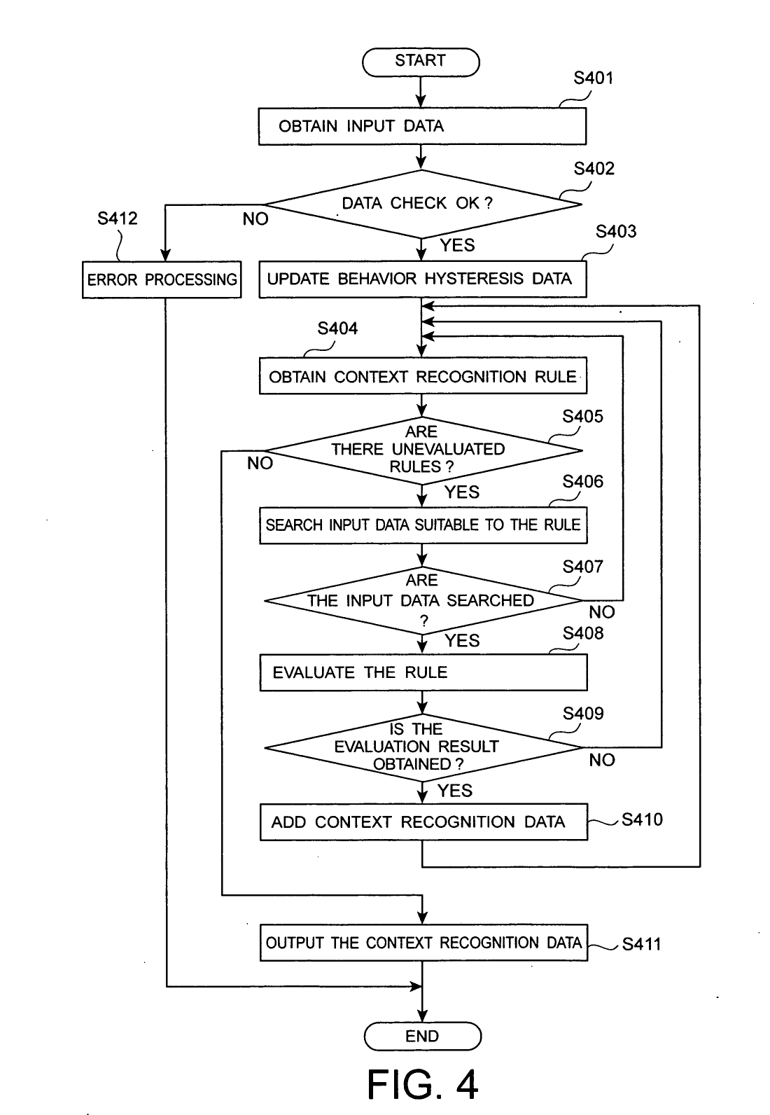

FIG. 4 is a flow chart of context recognition processing (S210) by the context recognition unit 110. As shown in FIG. 4, whenever the context recognition unit 110 obtains input data from outside (S401), in order not to process improper data, the context recognition unit 110 checks the input data (S402) by comparing a user identifier included in the input data with user identifiers stored in the user information management unit 101 or by verifying propriety of data format. In the case of proper data (Yes at S402), the context recognition unit 110 updates data in the behavior hysteresis management unit 102 (S403).

In the above-mentioned example, by the user's purchasing a carrot, the belonging data “carrot” is added to the behavior hysteresis management unit 102, and a price “200 yen” of the carrot is reduced from the user's money in hand. Furthermore, shopping memo data of “carrot” is deleted from the behavior hysteresis management unit 102, and To Do memo data “draw money” and “buy an onion” registered in a schedule management application is added to the behavior hysteresis management unit 102.

Next, the context recognition unit 110 obtains data in the behavior hysteresis management unit 102, such data including for example time in the system and the context recognition rule in the rule management unit 103, decides the user's context based on these data, and outputs context recognition data (S404˜S411).

Briefly, the context recognition unit 110 extracts each context recognition rule in the rule management unit 103 (S404). In the case of an unevaluated context recognition rule (Yes at S405), by referring to data format of input data indicated in the rule, the context recognition unit 110 searches input data suitable to the data format from the behavior hysteresis management unit 102 (S406). In the case of obtaining the input data (Yes at S407), the context recognition unit 110 evaluates this rule by matching the input data with the rule (S408).

If the evaluation result is obtained (Yes at S409), the context recognition data evaluated is added to a context recognition data list in the behavior hysteresis management unit 102 (S410). If the evaluation result is not obtained (No at S409), processing of S404-S409 is repeated. Furthermore, if there are unevaluated context recognition rules (Yes at S405), processing of S404-S410 is repeated. If there are no unevaluated context recognition rules (No at S405), context recognition data newly obtained by a series of context recognition processing is output (S411).

Furthermore, if the input data is decided as improper data by data check (No at 402), the context recognition unit 110 executes error processing such as notifying the impropriety to the user's terminal (S412).

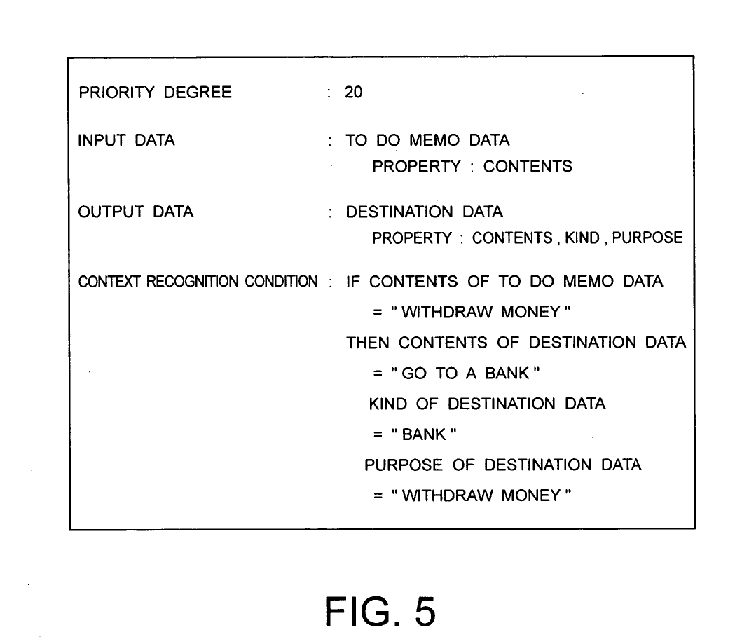

For example, in the context recognition rule of FIG. 5, input data is defined as “To Do memo data” and contents of “To Do memo data” is “withdraw money” as a trigger condition of the rule. Accordingly, in this case, the context recognition unit 110 obtains “To Do memo data” in the behavior hysteresis management unit 102, and checks whether contents of “To Do memo data” is “withdraw money”. In the above-mentioned example, because “To Do memo data” of “withdraw money” is already added to the behavior hysteresis management unit 102, it is confirmed that the trigger condition of the context recognition rule of FIG. 5 is satisfied. As a result, the context recognition unit 110 outputs “destination data” of “go to bank” as context recognition data.

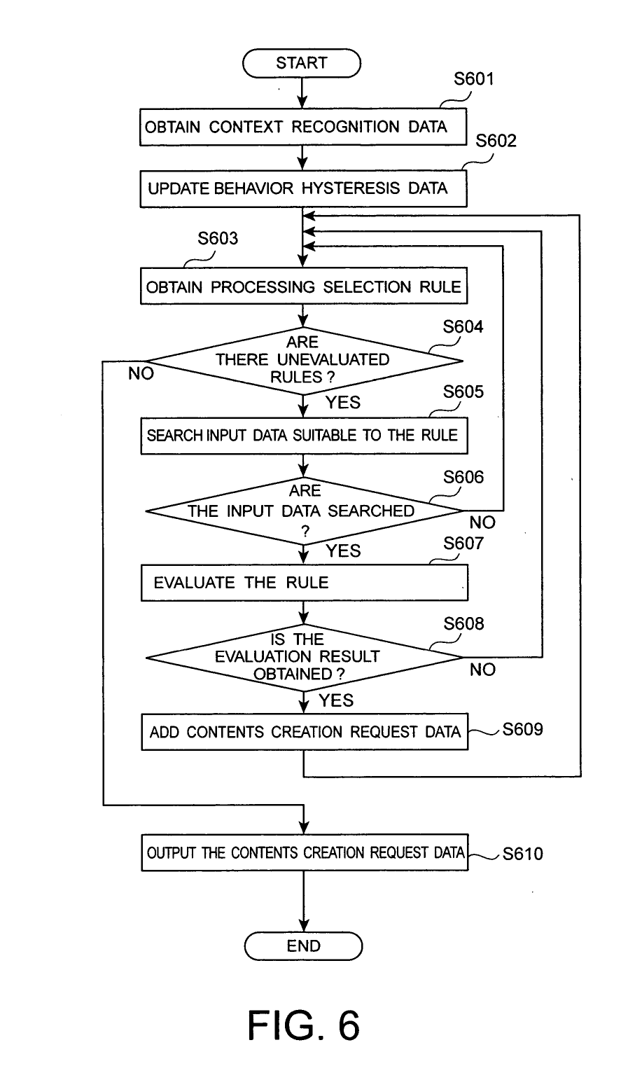

FIG. 6 is a flow chart of processing selection processing (S220) by the processing selection unit 120. Whenever the processing selection unit 120 obtains context recognition data output by the context recognition unit (S601), the processing selection unit 120 updates data in the behavior hysteresis management unit 102 (S601).

Next, the processing selection unit 120 obtains data in the behavior hysteresis management unit 102, such data including, for example, time in the system and the processing selection rule in the rule management unit 103, decides a contents type suitable to the user based on these data, and outputs contents creation request data (S603˜S610).

Briefly, the processing selection unit 120 extracts each processing selection rule in the rule management unit 103 (S603). In the case of an unevaluated processing selection rule (Yes at S604), by referring to data format of input data indicated in the rule, the processing selection unit 120 searches input data suitable to the data format from the behavior hysteresis management unit 102 (S605). In the case of obtaining the input data (Yes at S606), the processing selection unit 120 evaluates this rule by matching the input data with the rule (S607).

If the evaluation result is obtained (Yes at S608), the contents creation request data evaluated is added to a contents creation request data list in the behavior hysteresis management unit 102 (S609). If the evaluation result is not obtained (No at S608), processing of S603-S608 is repeated. Furthermore, if there are unevaluated processing selection rules (Yes at S604), processing of S603-S609 is repeated. If there are no unevaluated processing selection rules (No at S604), contents creation request data newly obtained by a series of processing selection processing is output (S610).

In this case, by continuing from the above-mentioned example, assume that the user passes near a bank, “neighboring institution data” of “near a bank” is output by latitude and longitude obtained using GPS function of cellular phone and by coordinate data of institution stored in the behavior hysteresis management unit 102, and the “neighboring institution data” is provided for the processing selection unit 120 as context recognition data.

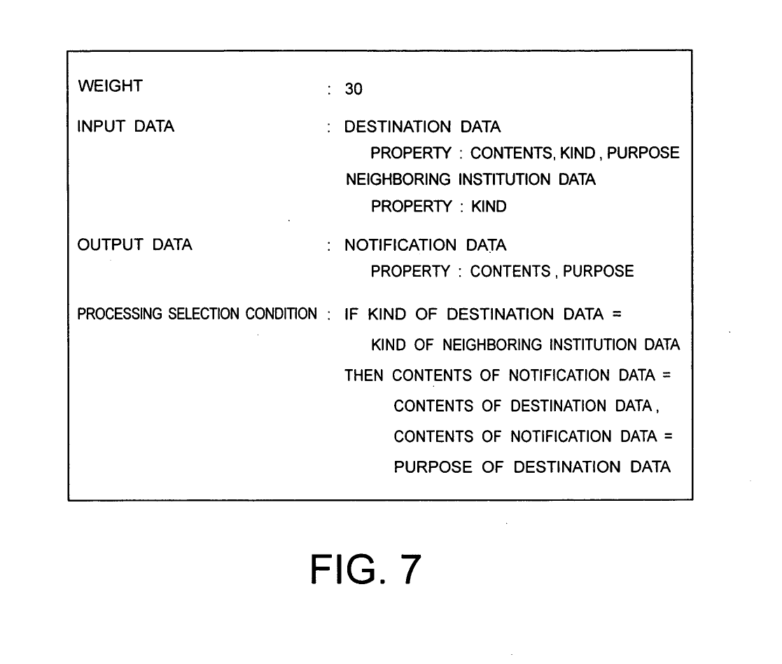

For example, in the processing selection rule of FIG. 7, input data is defined as “destination data” and “neighboring institution data”, and a trigger condition of the rule is that a kind of “destination data” is the same as a kind of “neighboring institution data”. Accordingly, in this case, the processing selection unit 120 obtains “destination data” and “neighboring institution data” in the behavior hysteresis management unit 102, and checks whether a kind of the destination data is the same as a kind of the neighboring institution data. In the above-mentioned example, destination data of “go to bank” and neighboring institution data of “near a bank” are already added to the behavior hysteresis management unit 102. Accordingly, it is confirmed that the trigger condition of the processing selection rule of FIG. 7 is satisfied. As a result, the processing selection unit 120 outputs “notification data” of “withdraw money from the bank” as contents creation request data.

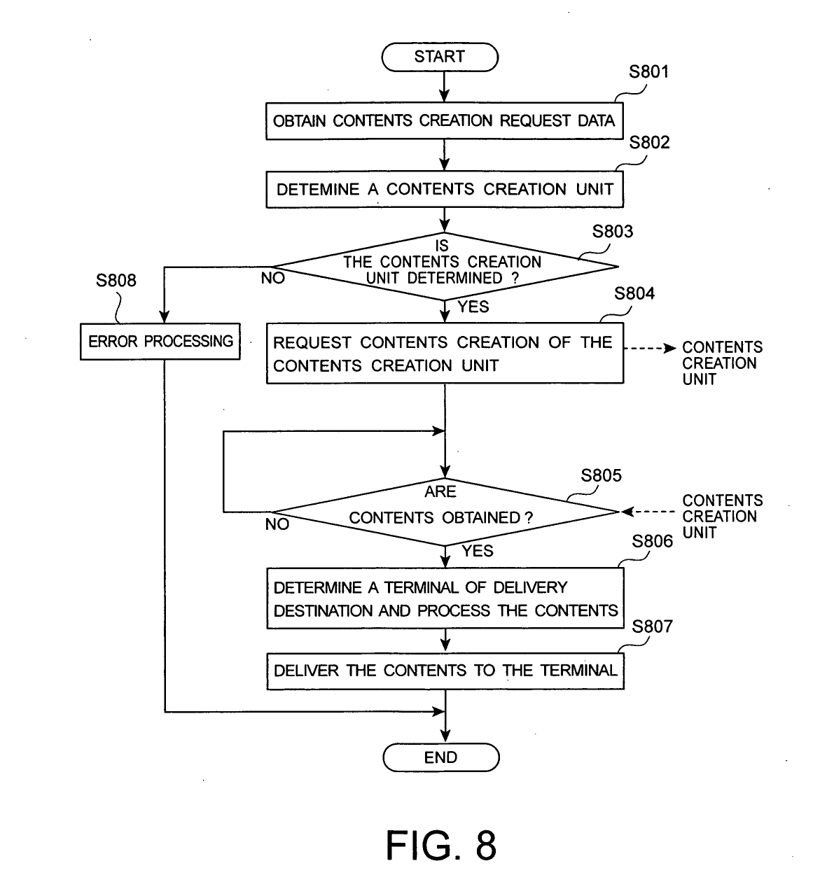

FIG. 8 is a flow chart of contents delivery processing (S230) by the contents delivery processing unit 130. As shown in FIG. 8, whenever the contents delivery unit 130 obtains contents creation request data output by the processing selection unit 120 (S901), the contents delivery unit 130 obtains contents based on the contents creation request data, and delivers the contents to the user (S802˜S806).

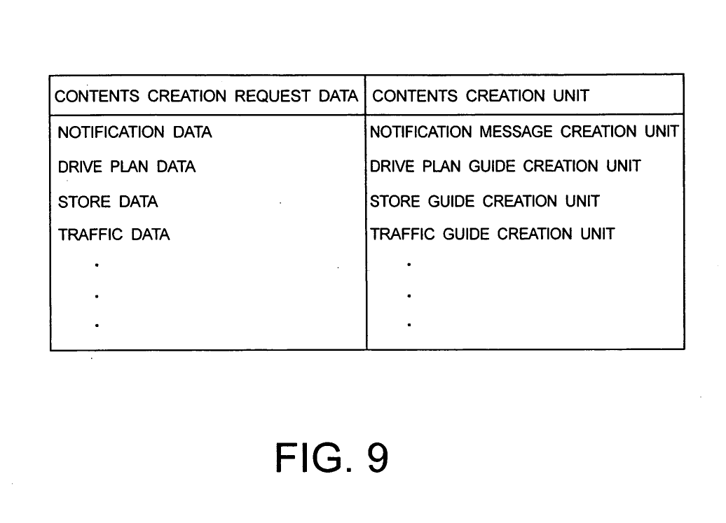

Briefly, based on contents creation request data output by the processing selection unit 120, the contents delivery unit 130 determines a contents creation unit corresponding to the contents creation request data by referring to a list of contents creation units (S802). FIG. 9 is one example of a correspondence table between contents creation request data and contents creation unit. If there is a contents creation unit corresponding to the contents creation request data (Yes at S803), the contents delivery unit 130 requests contents creation of the contents creation unit (S804).

After requesting contents creation, when the contents delivery unit 130 obtains contents created by the contents creation unit (Yes at S805), the contents delivery unit 130 selects a terminal of delivery destination from a plurality of user terminals U1-U4 related to the user based on data in the behavior hysteresis management unit 102, processes (modifies) the contents if necessary, and sends the contents to the terminal through the communication network in order to provide for the user.

Furthermore, if there is not a contents creation unit corresponding to the contents creation request data (No at S803), the contents delivery unit 130 executes error processing such as recreation of contents creation request data for the processing selection unit 120 (S808).

In the above-mentioned example, a contents creation unit corresponding to “notification data” of “withdraw money from the bank” is “notification message creation unit” in FIG. 9. Accordingly, “notification message” such as “Did you withdraw money from the bank?” is created from “notification data” of “withdraw money from the bank”. Furthermore, the contents delivery unit 130 may decide that the user is walking from the destination data “go to the bank” and the neighboring institution data “near the bank” in the behavior hysteresis management unit 102, and may determine contents provision for the user's cellular phone by a mail sending (push type). As a result, suitable information based on the user's real time context is provided to the user at a suitable time.

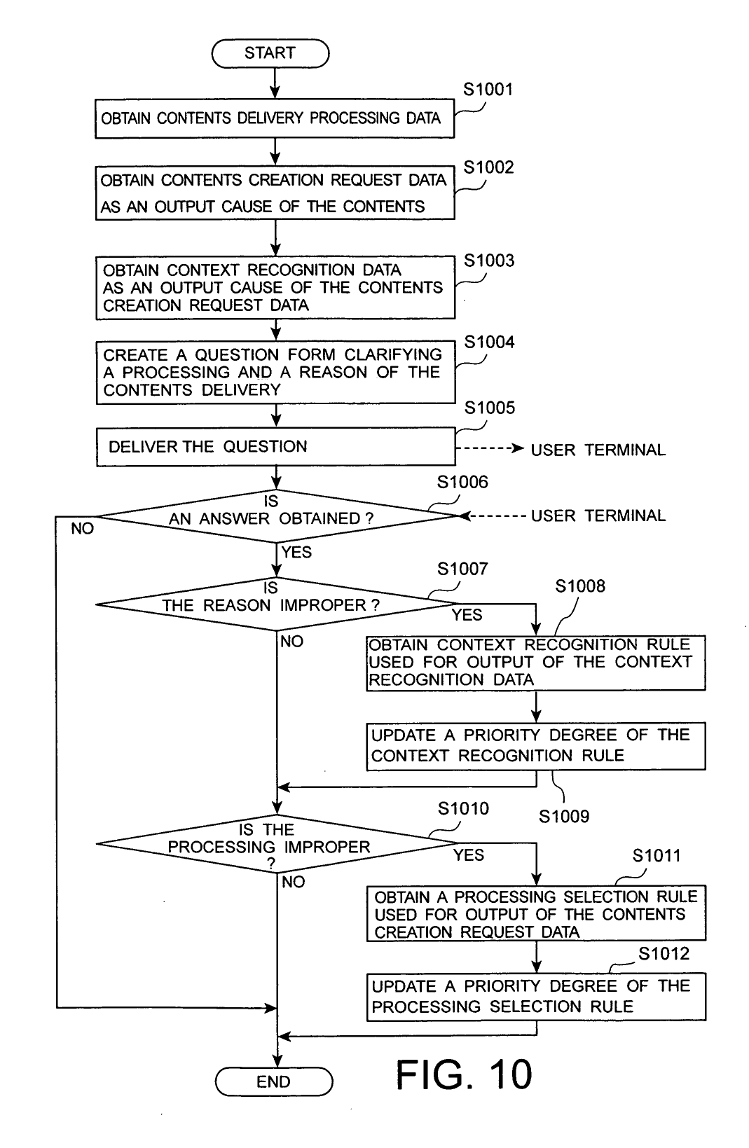

FIG. 10 is a flow chart of question creation processing (S240) by the question creation unit 140. As shown in FIG. 10, whenever the question creation unit 140 obtains data of contents delivery processing by generation of contents delivery from the contents delivery unit 130 to the user (S1001), the question creation unit 140 creates a question form about a reason and a processing of the contents delivery. When the question creation unit 140 receives the user's answer representing whether the reason and/or the processing of contents delivery was proper, the question creation unit 140 specifies the contents recognition rule and/or the processing selection rule based on the answer, and updates the priority degree of the specified rule (S1002˜S1010).

Briefly, the question creation unit 140 obtains the contents creation request data as an output cause of the contents delivered by the contents delivery unit 130 (S1002), and obtains the context recognition data as an output cause of the contents creation request data from the behavior hysteresis management unit 102 (S1003). Next, in order to obtain an answer representing whether the contents delivery is proper from the user, the question creation unit 140 creates a question form clarifying a reason of the contents delivery as the contents recognition data and a processing of the contents delivery (S1004).

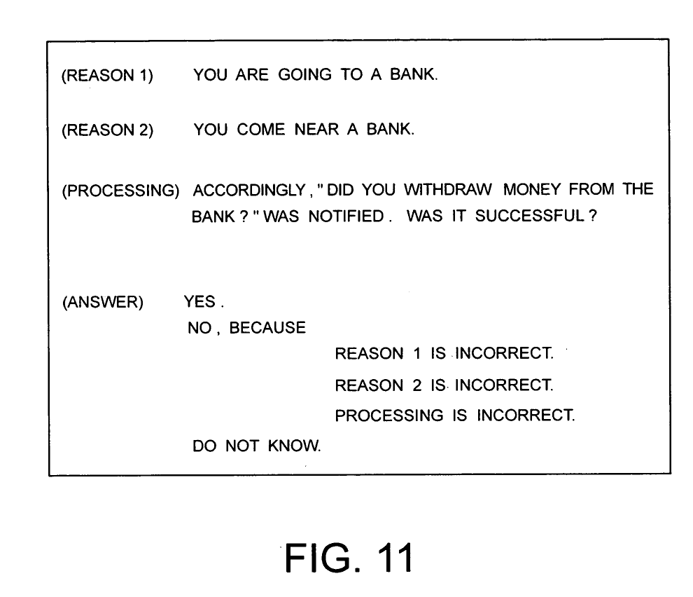

In the above-mentioned example, the contents delivery unit 130 creates a notification message “Did you withdraw money from the bank?” from notification data “withdraw money from the bank”, and delivers the notification message to the user's cellular phone. By monitoring this operation, the question creation unit 140 obtains destination data “go to a bank” and neighboring institution data “near a bank” as an output cause of notification data “withdraw money from the bank”. As a result, the question creation unit 140 creates a question form to disclose these data as a reason of the contents delivery with a processing of the contents delivery. For example, as shown in FIG. 11, a question “(Reason 1) You are going to a bank. (Reason 2) You come near a bank. (Processing) Accordingly, “Did you withdraw money from the bank?” was notified. Was it successful?” is created.

The question creation unit 140 sends the question form to the user's terminal through the communication network, and waits the user's answer (S1005). In this case, a timing to send the question can be freely selected. For example, if contents delivery processing by the contents delivery unit 130 does not cost much time, the question may be added to the contents and synchronously sent. Furthermore, if the contents delivery processing can not be cancelled, the question may be sent to the user's terminal before actual execution of the contents delivery processing. On the other hand, if the contents delivery processing costs much time or if appearance of effect of the contents delivery costs much time, the question may be unsynchronously sent to the user's terminal at a suitable timing.

When the question creation unit 140 receives the user's answer representing whether the contents delivery was proper (Yes at S1006), the question creation unit 140 executes rule update processing based on the answer. Briefly, if any reason of the contents delivery was improper (Yes at S1007), the question creation unit 140 obtains a context recognition rule used for output of the context recognition data corresponding to the reason from the rule management unit 103 (S1008), and updates data in the rule management unit 103 by decreasing a priority degree of the rule (S1009).

If the processing of the contents delivery was improper (Yes at S1010), the question creation unit 140 obtains a processing selection rule used for output of the contents creation request data corresponding to the processing from the rule management unit 103 (S1011), and updates data in the rule management unit 103 by decreasing a priority degree of the rule (S1012). Furthermore, if the user's answer is not obtained (No at S1006) or if the reason and the processing of the contents delivery were proper (No at S1007, No at S1010), the question processing is completed.

In the above-mentioned example, assume that “You come near a bank” is correct, but “You are going to a bank” is incorrect because the user withdrew money from a post office, and the user's answer “The processing is improper because the reason 1 is incorrect” is received. In this case, the question creation unit 140 obtains a context recognition rule (shown in FIG. 5) used for output of destination data “go to a bank” corresponding to the reason 1 from the rule management unit 103, and decreases a priority degree of this rule.

As a result, from the next time for the user, a priority degree of context recognition rule to output destination data “go to a bank” for To Do memo data “withdraw money” is decreased. Relatively, a priority degree of context recognition rule to output destination data “go to a post office” is increased. Accordingly, as for To Do memo data “withdraw money”, destination data “go to a post office” is preferentially output.

Furthermore, assume that “You come near a bank” is correct, “You are going to a bank” is correct, and the user's answer “Reasons 1 and 2 are correct, but the processing is improper because the notification is annoying for me” is received. In this case, the question creation unit 140 obtains a processing selection rule (shown in FIG. 7) used for output of the notification data “withdraw money from the bank” corresponding to the processing of contents delivery from the rule management unit 103, and decreases a priority degree of this rule. As a result, from the next time for the user, even if the destination data “go to a bank” and the neighboring institution data “near a bank” are obtained as the input data, the notification data of this rule is not output and the contents as the notification data is not delivered to the user's terminal.

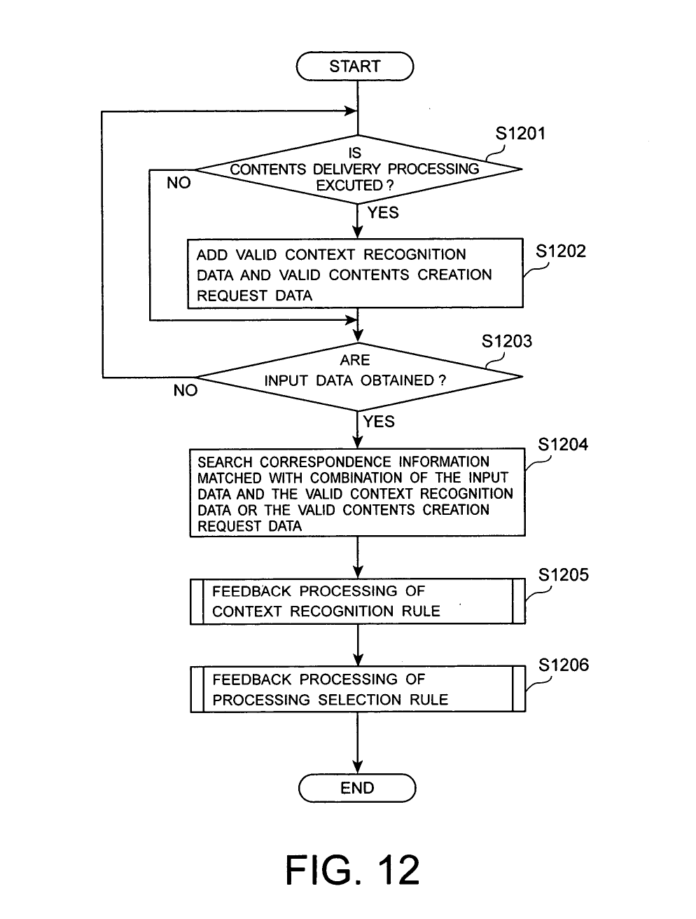

FIG. 12 is a flow chart of feedback processing (S250) by the feedback unit 150. As shown in FIG. 12, whenever the contents delivery unit 130 executes contents delivery processing (Yes at S1201), the feedback unit 150 obtains context recognition data actually output from the context recognition unit 110 or contents creation request data actually output from the processing selection unit 120. The feedback unit 150 adds the context recognition data to the valid context recognition data management unit 104, and adds the contents creation request data to the valid contents creation request data management unit 105 (S1202). In this case, the feedback unit 150 previously stores correspondence information between context recognition data (and contents creation request data) and input data.

Next, whenever input data are actually obtained from various kinds of information devices and the context recognition unit 110 begins context recognition processing (Yes at S1203), the feedback unit 150 searches the correspondence information matched with a pair of the input data and the (valid) context recognition data (or the (valid) contents creation request data) (S1204). Based on the searched correspondence information, a feedback processing of the context recognition rule (S1205) and/or a feedback processing of the processing selection rule (S1206) are executed.

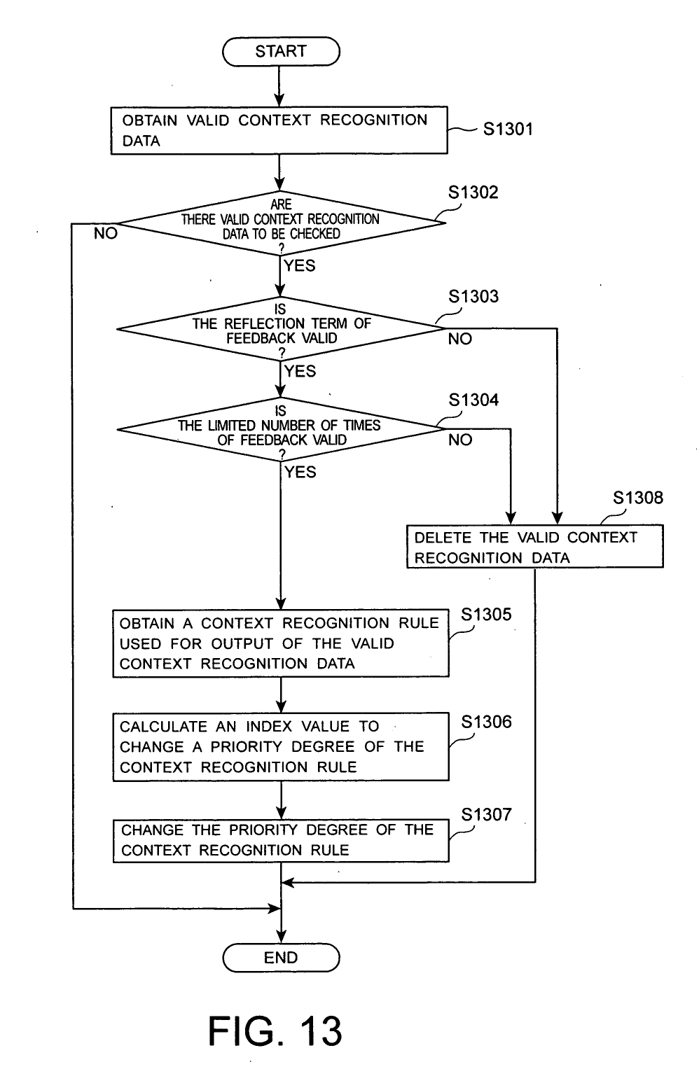

FIG. 13 is a flow chart of the feedback processing of the context recognition rule (S1205). As shown in FIG. 13, the feedback unit 150 obtains valid context recognition data from the valid context recognition data management unit 104 (S1301). If there are valid context recognition data to be checked (Yes at S1302), it is decided whether a reflection term of feedback is valid (S1303) and whether a limited number of times of feedback is valid (S1304) based on the correspondence information.

A decision of reflection term of feedback is whether a continuance term (passage of time from data addition) of the valid context recognition data is within the reflection term of feedback previously set as a time condition to feedback. Furthermore, a decision of limited number of times of feedback is whether an acceptance number of times of feedback of the valid context recognition data (number of times of feedback execution) is within the limited number of times of feedback previously set as a condition of number of times to feedback.

If the continuance term of the valid context recognition data is within the reflection term of feedback (Yes at S1303) and if the acceptance number of times of feedback of the valid context recognition data is within the limited number of times of feedback (Yes at S1304), a context recognition rule used for output of the valid context recognition data is obtained from the rule management unit 103 (S1305).

Furthermore, an index value to change a priority degree of the context recognition rule is calculated based on the input data (S1306), and the priority degree of the context recognition rule is updated based on the calculation result (S1307)

If the continuance term of the valid context recognition data is above the reflection term of feedback (No at S1303) or if the acceptance number of times of feedback of the valid context recognition data is above the limited number of times of feedback (No at S1304), this valid context recognition data is deleted from the valid context recognition data management unit 104 (S1308), and another valid context recognition data is obtained (S1301). When there are no valid context recognition data to be checked for the user (No at S1302), the feedback processing of context recognition rule is completed.

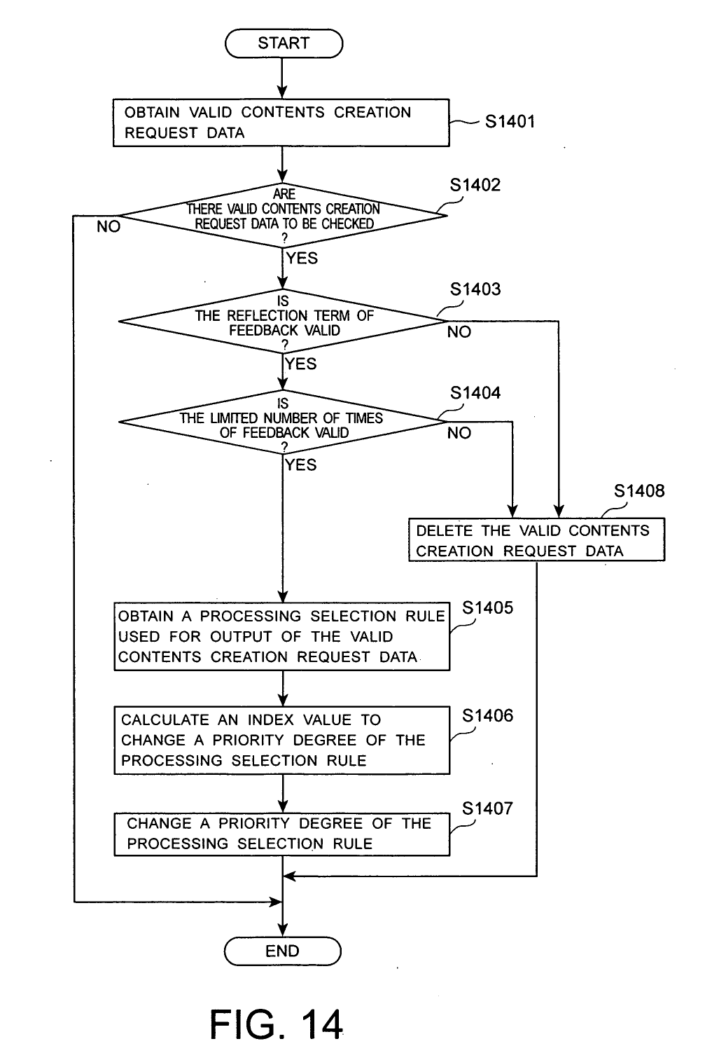

FIG. 14 is a flow chart of the feedback processing of processing selection rule (S1206). As shown in FIG. 14, by replacing the context recognition data with contents creation request data and replacing the context recognition rule with a processing selection rule, basic processing is the same as the feedback processing of context recognition rule of FIG. 13.

In the above-mentioned example, the contents delivery unit 130 creates a notification message such as “Did you withdraw money from the bank?” and delivers the notification message to the user's cellular phone. At this timing, by monitoring an operation of the contents delivery unit 130, the feedback unit 150 extracts destination data “go to a bank” and neighboring institution data “near a bank” from the behavior hysteresis management unit 102, and adds them to the valid context recognition data management unit 104. Furthermore, the feedback unit 150 adds the notification data “withdraw money from the bank” to the valid contents creation request data.

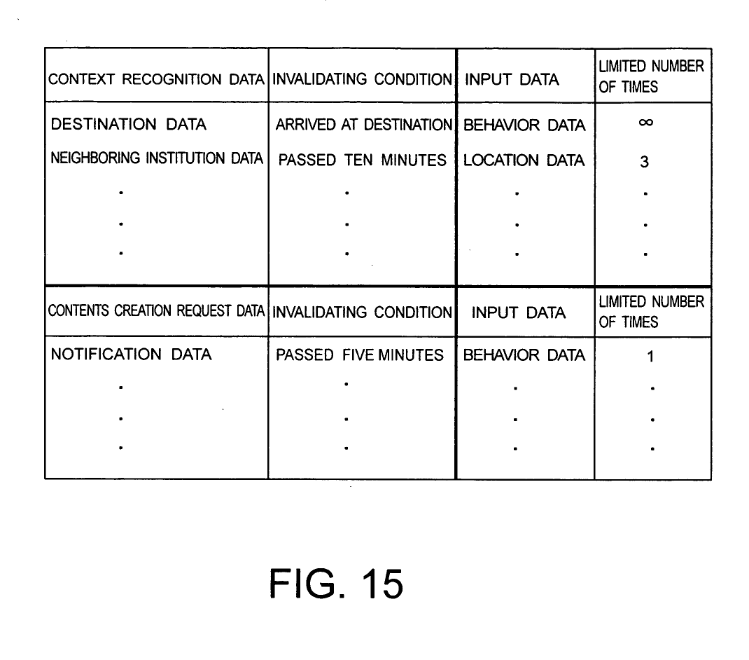

FIG. 15 is one example of a table of correspondence information among a kind of context recognition data (or a kind of contents creation request data), an invalidating condition which corresponding data become invalid, input data, and a limited number of times to accept corresponding data as feedback.

In the above-mentioned example, after fifteen minutes from delivering a notification message “Did you withdraw money from the bank?” by the contents delivery unit 130, assume that the user withdrew money from a post office near the bank. In this case, behavior data “withdraw money from a post office” and location data “post office” are provided for the feedback unit 150.

The valid context recognition data management unit 104 already stores the destination data “go to-a bank” and the neighboring institution data “near a bank”, and the valid contents creation request data management unit 105 already stores the notification data “withdraw money from a bank”. However, the neighboring institution data becomes invalid (is deleted) after ten minutes from addition of the data, and the notification data becomes invalid (is deleted) after five minutes from addition of the data. Accordingly, the feedback unit 150 decides feedback is not executed for the neighboring institution data and the notification data, but decides feedback is executed for the destination data only.

As for the destination data “go to a bank” in the table of FIG. 15, input data “behavior data” is indicated for feedback, and a context recognition condition of the behavior data (To Do memo data) is “withdraw money” as shown in FIG. 5. Accordingly, by obtaining behavior data from the behavior hysteresis management unit 102, the behavior data is checked whether it is “withdraw money”. In the above-mentioned example, a feedback condition is satisfied because behavior data “withdraw money from a post office” is already added to the behavior hysteresis management unit 102. As a result, the feedback unit 150 obtains a context recognition rule of FIG. 5 used for output of the destination data “go to a bank”, and calculates an index value to change a priority degree of the rule. Hereinafter, two methods for calculating the index value are explained.

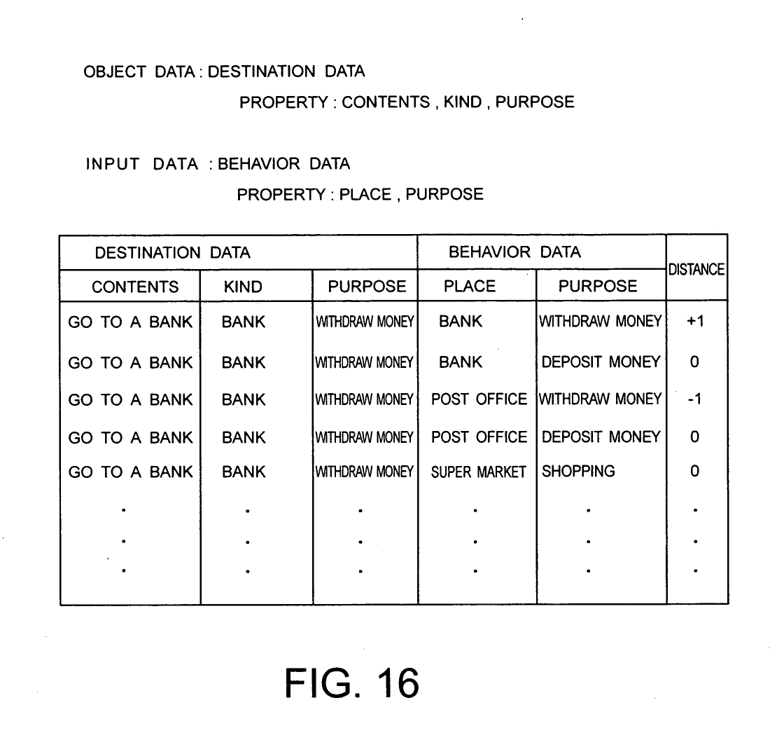

As a first method, the valid context recognition data management unit 104 and the valid contents creation request data management unit 105 store feedback data as a distance table. FIG. 16 is one example of the distance table between context recognition data (object data) and input data. As for the destination data “go to a bank” in FIG. 16, a distance for the behavior data “withdraw money from a bank” is “+1” and a distance for the behavior data “withdraw money from a post office” is “−1”. Accordingly, the index value for the destination data “go to a bank” is determined as “−1” by matching the behavior data “withdraw money from a post office”.

As a second method, the valid context recognition data management unit 104 and the valid contents creation request data management unit 105 store feedback data prescribing feedback condition as a feedback rule. The feedback unit 150 obtains input data in the behavior hysteresis management unit 102, such data including, for example, time in the system and the feedback rule in the rule management unit 103, and decides the feedback rule matched with the data in the valid context recognition data management unit 104 and the valid contents creation request data management unit 105.

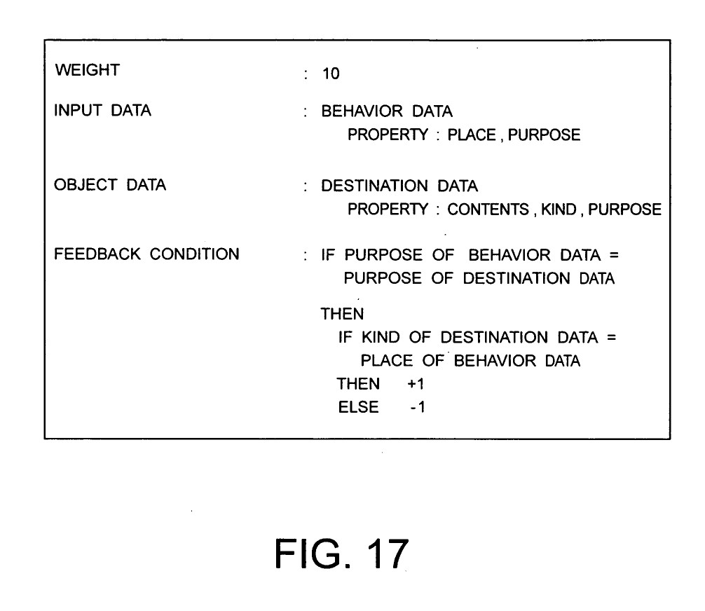

FIG. 17 is one example of the feedback rule. As shown in FIG. 17, input data is defined as “behavior data”, and a purpose of the destination data is “withdraw money” (shown in FIG. 5). The behavior data is obtained from the behavior hysteresis management unit 102 and the behavior data is checked whether it is “withdraw money”. In the above-mentioned example, behavior data “withdraw money from a post office” is already added to the behavior hysteresis management unit 102. Accordingly, feedback data to give “+1” for destination data “go to a post office” and feedback data to give “−1” for destination data “go to a bank” are output.

In both methods, feedback to the destination data “go to a bank” in the valid context recognition data management unit 104 is “−1”. Accordingly, the feedback unit 105 obtains a context recognition rule of FIG. 5 used for output of the destination data “go to a bank” from the rule management unit 103, and decreases a priority degree of the rule by “−1”. As a result, as for To Do memo data “withdraw money” from the next time, a priority degree to output destination data “go to a bank” is low while a priority degree to output destination data “go to a post office” is relatively high. Accordingly, as for To Do memo data “withdraw money”, destination data “go to a post office” is output. Furthermore, in the above-mentioned example, destination data “go to a bank” is deleted when the user's To Do (behavior) is completed by inputting the behavior data “withdrew money from a post office”.

In this way, by setting a valid term for the context recognition data and the contents creation request data to accept feedback and by setting a limited number of times of feedback for input data, feedback is not excessively executed and a priority degree of the rule is suitably updated for the user.

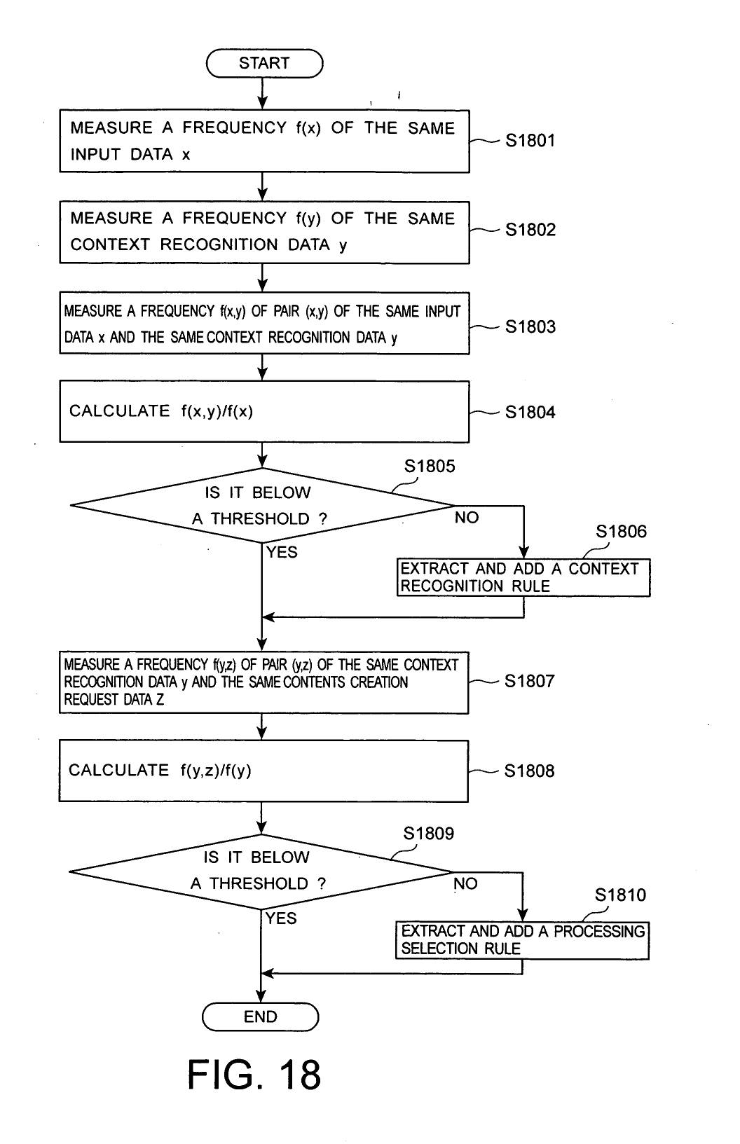

FIG. 18 is a flow chart of the rule extraction processing (S260) by the rule extraction unit 160. As shown in FIG. 18, at a predetermined interval, or whenever a predetermined number of times of the context recognition processing or the processing selection processing is executed, the rule extraction unit 160 analyzes a user's behavior by referring to input data (obtained from various kinds of information devices), context recognition data, and contents creation request data in the behavior hysteresis management unit 102.

First, the rule extraction unit 160 extracts each input data (obtained from various kinds of information devices) from the behavior hysteresis management unit 102, and measures (counts) a frequency f(x) of the same input data x (S1801). In the same way, the rule extraction unit 160 extracts each context recognition data from the behavior hysteresis management unit 102, and measures a frequency f(y) of the same context recognition data y (S102). Next, the rule extraction unit 160 extracts each pair of the context recognition data and the input data from the behavior hysteresis management unit 102, and measures a frequency f(x,y) of a pair (x,y) of the same input data x and the same context recognition data y (S103). Based on the measured frequencies, the rule extraction unit 160 calculates a ratio or strength f(x,y)/f(x) of connection between the input data and the context recognition data (S1804). If the strength of connection is not below a threshold (No at S1805), the rule extraction unit 160 extracts a new context recognition rule from the pair of the input data and the context recognition data, and adds the new context recognition rule to the rule management unit 103 (S1806).

Next, the rule extraction unit 160 extracts each pair of the context recognition data and the contents creation request data from the behavior hysteresis management unit 102, and measures a frequency f(y,z) of a pair (y,z) of the context recognition data y and the contents creation request data z (S1807). Based on the measured frequencies, the rule extraction unit 160 calculates a strength f(y,z)/f(y) of connection between the context recognition data and the contents creation request data (S109). If the strength of connection is not below a threshold (No at S1809), the rule extraction unit 160 extracts new processing selection rule from the pair of the context recognition data and the contents creation request data, and adds the new processing selection rule to the rule management unit 103 (S1810).

For example, if a large number of combinations of To Do memo data “buy an onion”, location data “convenience store”, and user's belongings data “onion” are stored in the behavior hysteresis management unit 102, a connection of these data is decided to be strong based on the frequency. In this case, a context recognition rule “go to a convenience store in the case of buying an onion” is extracted from these data and added to the rule management unit 103. As a result, a new rule is created without the user's input of the rule, and contents creation can dynamically and finely follow the user's situation of service use in real time.

As mentioned-above, in the present embodiment, a hysteresis of input data such as time and location obtained from various kinds of information devices on a communication network (and the user's information) may be completely decided based on the context recognition rule previously stored. Accordingly, at the timing, context recognition data related to the user's present situation can be output. Furthermore, a hysteresis of the context recognition data (and the user's information) may be completely decided based on the processing selection rule previously stored. Accordingly, contents suitable for the user's present situation can be dynamically created.

Furthermore, the context recognition data used for output of the contents creation request data is disclosed as a reason of contents delivery to the user, and a question representing whether the contents delivery was proper is presented to the user. In response to the user's answer, the context recognition rule and the processing selection rule are arbitrarily updated. Accordingly, by dynamically updating the rule based on the user's latest situation, contents suitable for the user can be dynamically created.

Furthermore, in parallel with the context recognition processing, the processing selection processing, the contents delivery processing, and the question creation processing, the feedback processing and the rule extraction processing are executed. Accordingly, the rule stored in the system can be dynamically updated for the user.

Briefly, in the feedback processing, a hysteresis of input data such as time and location obtained from various kinds of information devices (and the user's information) may be used as feedback (whether the created contents were suitable for the user) for the created contents. Accordingly, the rule stored in the system can be dynamically updated for the user.

Furthermore, in the rule extraction processing, based on a frequency of input data obtained from various kinds of information devices, a frequency of context recognition data output based on the input data, a frequency of contents creation request data, and a frequency of combination of these data, a rule stored in the system can be dynamically updated for the user.

In this way, in the present embodiment, by a plurality of methods such as the question creation processing, the feedback processing, and the rule extraction processing, the rule to output the context recognition data and the contents creation request data can be dynamically updated for the user. Accordingly, contents creation can dynamically and precisely follow the user's situation of service use in real time.

For embodiments of the present invention, the processing of the present invention can be accomplished by a computer-executable program, and this program can be realized in a computer-readable memory device.

In embodiments of the present invention, the memory device, such as a magnetic disk, a floppy disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory-devices may be included in the memory device. The component of the device may be arbitrarily composed.

In embodiments of the present invention, the computer executes each processing stage of the embodiments according to the program stored in the memory device. The computer may be one apparatus such as a personal computer or a system in which a plurality of processing apparatuses are connected through a network. Furthermore, in the present invention, the computer is not limited to a personal computer. Those skilled in the art will appreciate that a computer includes a processing unit in an information processor, a microcomputer, and so on. In short, the equipment and the apparatus that can execute the functions in embodiments of the present invention using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. An apparatus for providing contents through a communication network, comprising:
a context recognition unit configured to decide a user's context by comparing context recognition rules to present information related to the user, the present information being data sent from a plurality of information devices through the communication network, and configured to output context recognition data based on the user's context;
a processing selection unit configured to decide a contents type by comparing processing selection rules to the context recognition data, and configured to output contents creation request data based on the contents type;
a contents delivery unit configured to obtain contents based on the contents creation request data, and configured to deliver the contents to a terminal related to the user; and
a question creation unit configured to create at least one question about the contents delivery, the question being delivered in correspondence with the contents;
wherein each context recognition rule and each processing selection rule include a priority degree for matching, and
wherein said question creation unit, in response to the user's answer to the question, specifies the context recognition rule or the processing selection rule based on the answer, and changes the priority degree of the specified rule.

2. The apparatus according to claim 1,
wherein the present information is private data of the user oneself.

3. The apparatus according to claim 1,
further comprising a plurality of contents creation units each configured to differently create contents corresponding to the contents type, and
wherein said contents delivery unit selects one of the plurality of contents creation units based on the contents creation request data.

4. The apparatus according to claim 1,
further comprising a rule management unit configured to store a plurality of context recognition rules and a plurality of processing selection rules,
wherein each context recognition rule includes a context recognition condition as an if-then rule of input data and output data, and
wherein each processing selection rule includes a processing selection condition as an if-then rule of input data and output data.

5. The apparatus according to claim 4,
wherein said context recognition unit selects one context recognition rule of which input data is matched with the present information, and provides the output data included in the one context recognition rule as the context recognition data, and
wherein said processing selection rule selects one processing selection rule of which input data is matched with the context recognition data, and provides the output data included in the one processing selection rule as the contents creation request data.

6. The apparatus according to claim 5,
wherein the at least one question includes the context recognition data as a reason of the contents delivery, the contents creation request data as a processing of the contents delivery, and a selection answer representing whether the reason is correct and whether the processing is correct.

7. The apparatus according to claim 5,
further comprising a behavior hysteresis management unit configured to store the context recognition data, the contents creation request data, behavior data, and location data, the behavior data and the location data being the present information of the user.

8. The apparatus according to claim 6,
wherein, if the user's answer represents whether the reason is correct, said question creation unit specifies the context recognition rule used for output of the context recognition data, and updates the priority degree of the specified context recognition rule based on the user's answer.

9. The apparatus according to claim 6,
wherein, if the user's answer represents whether the processing is correct, said question creation unit specifies the processing selection rule used for output of the contents creation request data, and updates the priority degree of the specified processing selection rule based on the user's answer.

10. The apparatus according to claim 2,
further comprising a feedback unit configured to previously store correspondence information between at least one of the context recognition data and the contents creation request data, and the data obtained from the plurality of information devices, and to search the correspondence information matched with output data from said context recognition unit or said processing selection unit and input data from the plurality of information devices.

11. The apparatus according to claim 10,
wherein said feedback unit specifies the context recognition rule if the output data is the context recognition data, specifies the processing selection rule if the output data is the contents creation request data, and updates the priority degree of the specified rule based on the correspondence information.

12. The apparatus according to claim 11,
wherein the correspondence information is a table describing an update method of the priority degree of the specified rule.

13. The apparatus according to claim 11,
wherein the correspondence information is an if-then rule describing a condition between the input data and the output data, and a conclusion as a update method of the priority degree of the specified rule.

14. The apparatus according to claim 11,
wherein the correspondence information includes an invalidating condition as an effective term for each pair of the context recognition data or the contents creation request data and the input data.

15. The apparatus according to claim 14,
wherein the correspondence information includes a limited number of times of update of the specified rule for each pair of the context recognition data or the contents creation request data and the input data.

16. The apparatus according to claim 7,
further comprising a rule extraction unit configured to count a first frequency of the same input data, a second frequency of the same context recognition data, a third frequency of each pair of the same input data and the same context recognition data, and a fourth frequency of each pair of the same context recognition data and the same contents creation request data.

17. The apparatus according to claim 16,
wherein said rule extraction unit calculates a ratio of the third frequency to the first frequency, extracts a context recognition rule from the pair of the same input data and the same context recognition data if the ratio is above a threshold, and preserves the context recognition rule in the rule management unit.

18. The apparatus according to claim 17,
wherein said rule extraction unit calculates a ratio of the fourth frequency to the second frequency, extracts a processing selection rule from the pair of the same context recognition data and the same contents creation request data if the ratio is above a threshold, and preserves the processing selection rule in the rule management unit.

19. A method for providing contents through a communication network, comprising:
deciding a user's context by comparing context recognition rules to present information related to the user, each context recognition rule including a priority degree for matching, the present information being data sent from a plurality of information devices through the communication network;
outputting context recognition data based on the user's context;
deciding a contents type by comparing processing selection rules to the context recognition data, each processing selection rule including a priority degree for matching;
outputting contents creation request data based on the contents type;
obtaining contents based on the contents creation request data;
delivering the contents to a terminal related to the user;
creating at least one question about the contents delivery, the question being delivered in correspondence with the contents;
specifying the context recognition rule or the processing selection rule based on the user's answer to the question; and
changing the priority degree of the specified rule.

20. A computer program product, comprising:
a computer readable program code embodied in said product for causing a computer to provide contents through a communication network, said computer readable program code comprising:
a first program code to decide a user's context by comparing context recognition rules to present information related to the user, each context recognition rule including a priority degree for matching, the present information being data sent from a plurality of information devices through the communication network;
a second program code to output context recognition data based on the user's context;
a third program code to decide a contents type by comparing processing selection rules to the context recognition data, each processing selection rule including a priority degree for matching;
a fourth program code to output contents creation request data based on the contents type;
a fifth program code to obtain contents based on the contents creation -request data;
a sixth program code to deliver the contents to a terminal related to the user;
a seventh program code to create at least one question about the contents delivery, the question being delivered in correspondence with the contents;
a eighth program code to specify the context recognition rule or the processing selection rule based on the user's answer to the question; and
a ninth program code to change the priority degree of the specified rule.
